(19) United States
(12) Patent Application Publication
(10) Pub. No.: US 2003/0000256 A1
(43) Pub. Date: Jan. 2, 2003

(54) Filament housing for fiber splicing and lens fabrication processes

(76) Inventors: Ljerka Ukrainczyk, Painted Post, NY (US); Debra L. Vastag, Elmira Heights, NY (US)

Correspondence Address: CORNING INCORPORATED, SP-TI-3-1, CORNING, NY, 14831

(21) Appl. No.: 09/832,668

(22) Filed: Apr. 11, 2001

(51) Int. Cl. C03B 37/07

(52) U.S. Cl. 65/404; 65/424; 65/433; 65/484; 65/377

(57) ABSTRACT

An apparatus for conducting a fusion process includes a first chamber and a second chamber which maintains an atmosphere that is substantially free of oxygen. A closeable passage connects the second chamber and the first chamber and selectively provides substantial isolation of the second chamber from the first chamber. A filament normally disposed in the second chamber is moveable between the second chamber and the first chamber when the closeable passage is in an open position.

### BACKGROUND OF INVENTION

1. Field of the Invention

The invention relates to a method and an apparatus for optically coupling a fiber to an optical element such as a lens or another fiber.

2. Background Art

Fiber collimators are used in almost all micro-optic devices to couple light between optical fibers and micro-optic elements. FIG. 1 shows a micro-optic device 1 comprising micro-optic elements 2, such as filters, polarizers, etc., aligned with an input fiber 3 and an output fiber 4. Because optical fibers are divergent in nature, when the light 7 transmitted through the input fiber 3 exits the fiber, it diverges rapidly. A collimating lens 5, such as ball lens, graded-index (GRIN) lens, asphere, etc., is inserted at the end of the input fiber 3 to collimate the light. Another collimating lens 6 is inserted at the output fiber 4 to gather the light after it has passed through the micro-optic elements 2. To ensure proper optical coupling, the collimating lenses 5, 6 must be properly aligned with the optical fibers 3, 4 in three dimensions.

Various mechanical methods for coupling lenses to optical fibers are known in the art. FIG. 2 shows an example where an optical fiber 10 is mechanically coupled to a lens 12 by an alignment device 14. A refractive-index matching agent 16 is disposed between the optical fiber 10 and lens 12 to minimize reflection of the light signal. Coupling the lens 12 to the optical fiber 10 in the manner shown in FIG. 2 requires aligning the optical fiber 10 and the optical axis position of the lens 12 at submicron level. This process can be very time consuming. Because the lens 12 is independent of the optical fiber 10 and must be precisely aligned with the optical fiber 10, fabricating this type of fiber-optic system is expensive and may result in decreased efficiency in optical coupling. This is also true for independent lens systems that are attached to optical fibers by other means such as gluing. In the case of gluing, the materials used to bond the lens to the fiber can present reliability problems in terms of micro-movement of the lens and fiber in hostile operating conditions.

U.S. Pat. No. 5,293,438 issued to Konno et al. proposes a solution which includes integrally forming the lens with the fiber using a fusion process. An optical fiber with an integrally formed lens is referred to as a microlensed fiber. Referring to FIG. 3, a method for forming a microlensed fiber 20 involves fusion-splicing an optical fiber 22 to a rod 24. The rod 24 is made of a lens material such as silica or borosilicate. A lens 26 is formed from the rod 24 by a fusion process. One of the primary advantages of a microlensed fiber is simplified packaging because the lens is already aligned with and integrally formed with the fiber. Thus, there is no need for mechanically attaching or gluing the lens to the fiber. Also, a microlensed fiber can be made in a wide range of sizes so that its spot size and working range can be tailored for a particular application. Microlensed fiber consisting of silica plano-convex lens fusion-spliced to an optical fiber has been proposed as a replacement for GRIN lens in micro-optic packages.

In general, fabrication of a microlensed fiber involves four basic steps: (1) prepositioning, (2) splicing, (3) taper cutting, and (4) melting back. Referring to FIG. 2, prepositioning involves aligning the optical fiber 22 with the rod 24. The optical fiber 22 and the rod 24 are axially aligned with ends proximal each other in a way similar to aligning two fibers for standard fusion splicing. Splicing involves pushing the opposing ends of the optical fiber 22 and the rod 24 together while heating them to fuse or melt the ends together. Taper cutting involves moving the heat source to a desired location along the rod 24 to taper the rod 24 to a desired length. Melting back involves moving the heat source back towards the splice 25, i.e., the joint between the optical fiber 22 and the rod 24, by a selected distance to form the lens 26. The distance the heat source is moved back towards the splice 25 depends on the desired radius of curvature for the lens 26. The closer the heat source is to the splice 25, the larger the radius of curvature of the lens 26.

Fabrication of a microlensed fiber, such as the microlensed fiber 20 shown in FIG. 3, requires a uniform heat source to allow for a formation of a substantially perfectly spherical lens 26 at the end of the fiber 22. One possible heat source is a standard fusion splicer with a tungsten filament. FIG. 4 shows a cassette 30 used in a standard fusion splicer. The cassette 30 includes a tungsten filament loop 32, which has been shown to provide exceptionally uniform heat that allows for the formation of a spherical lens with a symmetrical circular mode field. An example of this type of standard fusion splicer is one sold under the trade name FFS-2000 by Vytran Corporation of Morganville, N.J. However, manufacturing microlensed fibers using a standard fusion splicer, such as sold under the trade name FFS-2000 by Vytran Corporation, has not been practical because the lifetime of the filament of the fusion splicer is very short, at least in comparison to when the fusion splicer is used for fusion-splicing of fibers. The reasons for this short filament lifetime are discussed below.

Filament powers required during fabrication of a microlensed fiber are generally higher than the filament power required for standard fusion-splicing of fibers. For example, using a standard filament loop on a Vytran FFS-2000 splicer with a 15 Amp DC power supply, the filament powers required to fabricate a microlensed fiber from an optical fiber, such as a Corning® SMF-28™ optical fiber, and a 200 micron diameter silica rod are 21 W for splicing, 26 W for taper cutting, and 31 W for melting back. On the other hand, the filament power required for standard fusion-splicing of optical fibers, such as a Corning® SMF-28™ optical fiber to another Corning® SMF-28™ optical fiber, is 21 W. Table 1 below shows typical filament powers required for fabrication of microlensed fiber depending on rod material.

TABLE 1
Filament powers required for fabrication of microlensed fiber

| | Filament Power (Watts, W) | | |
|---|---|---|---|
| Process | Silica | B₂O₃-SiO₂ | GeO₂-SiO₂ |
| Splicing | 21 | 18 | 19 |
| Taper cut | 26 | 21 | 24 |
| Melt back | 31 | 24 | 26 |

In addition, during fabrication of a microlensed fiber, the filament is on much longer than when used to make a standard fiber-to-fiber splice. For example, the filament of the fusion splicer sold under the trade name FFS-2000 by Vytran Corporation is on an average of about 25 seconds when forming a lens using the method described above and only an average of 5 seconds when forming a standard fiber-to-fiber splice. Because the filament powers for lens formation are much higher and the filament stays on much longer, the lifetime of the filament is greatly reduced when used for lens fabrication. For example, while a filament, such as the filament of the fusion splicer sold under the trade name FFS-2000 by Vytran Corporation, can typically make around 500 fiber-to-fiber splices, it is typically only capable of making a maximum of about 80 lenses when silica is used as the lens material and about 150 lenses when borosilicate glass is used as the lens material.

Another reason for a short filament lifetime using existing technology, such as the FFS-2000 fusion splicer sold by Vytran Corporation, is that the tungsten filament of the fusion splicer is exposed to air. In the current fusion processes, the filament loop, which is run with a DC current, sits inside a splice head that is completely open to air. Exposure of the tungsten filament to air results in tungsten oxidation. When the filament is used for splicing or making a lens, the filament is purged with argon at about 0.5 to 1 L/min. However, when the filament is not in use, it is exposed to air. Tungsten oxide has a much lower melting point than tungsten metal, which leads to constant evaporation of oxidized tungsten from the surface of the filament until the filament is so thin that it breaks.

Although other sources of heat, such as a CO₂ laser, may potentially be used for fabricating a microlensed fiber, these sources have not been shown to provide heat that is sufficiently uniform and controlled to allow for the level of lens reproducibility necessary for production. On the other hand, filament loops, such as in fusion splicers, have been shown to achieve a select rate of 90% or better in the production of microlensed fiber with a working distance of 4 mm when borosilicate glass is used as the lens material. The term “select rate” is the number of lenses that meet the specification. With a working distance of 4 mm, the size of lenses that can be made is limited. However, larger lenses can be made if the filament loop is made larger. Because filament lifetime is a major limitation on fabrication processes for microlensed fiber, a new apparatus and method for increasing the lifetime of a filament is needed and desired.

### SUMMARY OF INVENTION

In one aspect, the invention relates to an apparatus for conducting a fusion process which comprises a first chamber and a second chamber maintaining an atmosphere that is substantially free of oxygen. A closeable passage connects the first chamber and the second chamber and selectively provides substantial isolation of the second chamber from the first chamber. A filament normally disposed in the second chamber is movable between the second chamber and the first chamber when the closeable passage is in an open position.

In another aspect, the invention relates to an apparatus for conducting a fusion process which comprises a first chamber and a plurality of second chambers. A closeable passage connects a selected one of the second chambers to the first chamber and selectively provides substantial isolation of the selected one of the second chambers from the first chamber. A filament disposed in the selected one of the second chambers is movable between the selected one of the second chambers and the first chamber when the closeable passage is in an open position. The selected one of the second chambers maintains an atmosphere that is substantially free of oxygen.

In another aspect, the invention relates to an apparatus for fabricating a microlensed fiber which comprises a first chamber having a plurality of fiber holders through which fibers are inserted into the first chamber. The apparatus further includes a second chamber which maintains a substantially inert atmosphere. A closeable passage disposed between the first chamber and the second chamber selectively provides substantial isolation of the second chamber from the first chamber. A filament normally disposed in the second chamber is movable between the second chamber and the first chamber when the closeable passage is in an open position.

In another aspect, the invention relates to a method for extending a lifetime of a filament used in a fusion process. The method comprises disposing the filament in a second chamber which maintains an atmosphere that is substantially free of oxygen, extending the filament into a first chamber for the fusion process, and retracting the filament back into the second chamber after the fusion process.

In another aspect, the invention relates to a method for making microlensed fibers which comprises aligning a fiber and a rod made of lens material in a first chamber. The method further comprises extending a filament from a second chamber which maintains an atmosphere that is substantially free of oxygen to the first chamber. The method further comprises fusion splicing the fiber to the rod and forming a lens from the rod using the filament.

Other aspects and advantages of the invention will be apparent from the following description and the appended claims.

### BRIEF DESCRIPTION OF DRAWINGS

FIG. 1 is a schematic representation of a micro-optic device.

FIG. 2 is a schematic of a prior art method for coupling a lens to an optical fiber.

FIG. 3 is a schematic of a prior art microlensed fiber.

FIG. 4 shows a prior art fusion splicer with a filament loop.

FIG. 5 is a front view of an apparatus for fabricating a microlensed fiber in accordance with one embodiment of the invention.

FIG. 6A is a vertical cross-section of the apparatus shown in FIG. 5.

FIG. 6B is a horizontal cross-section of the apparatus shown in FIG. 5.

FIG. 7 is a front view of an apparatus for fabricating a microlensed fiber in accordance with another embodiment of the invention.

FIG. 8 shows filament chambers mounted on a carousel.

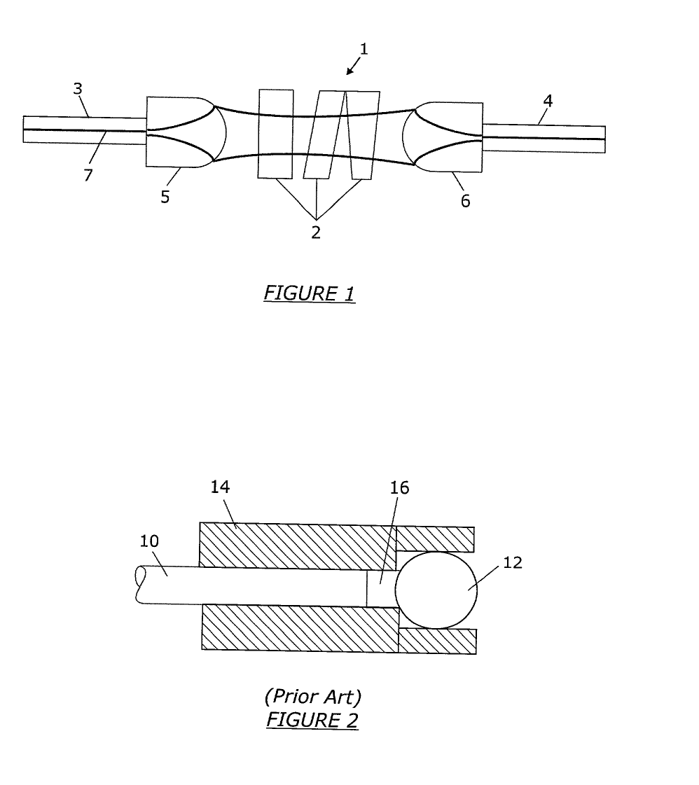

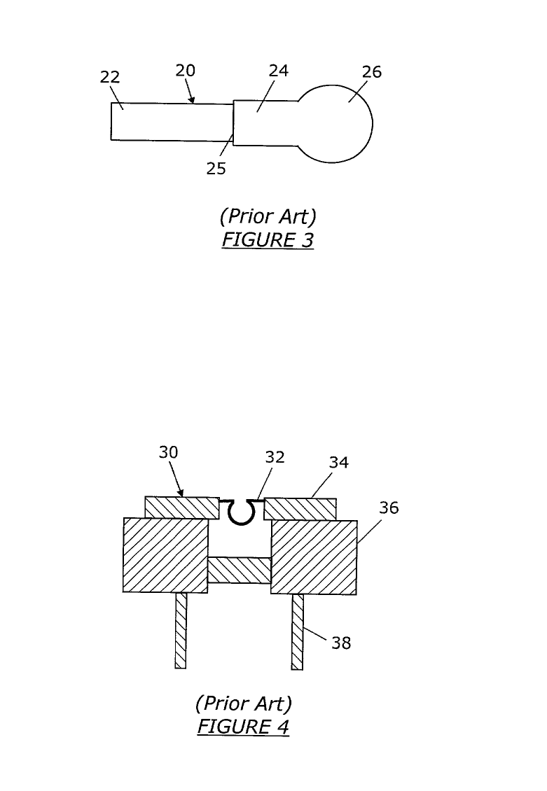

### DETAILED DESCRIPTION

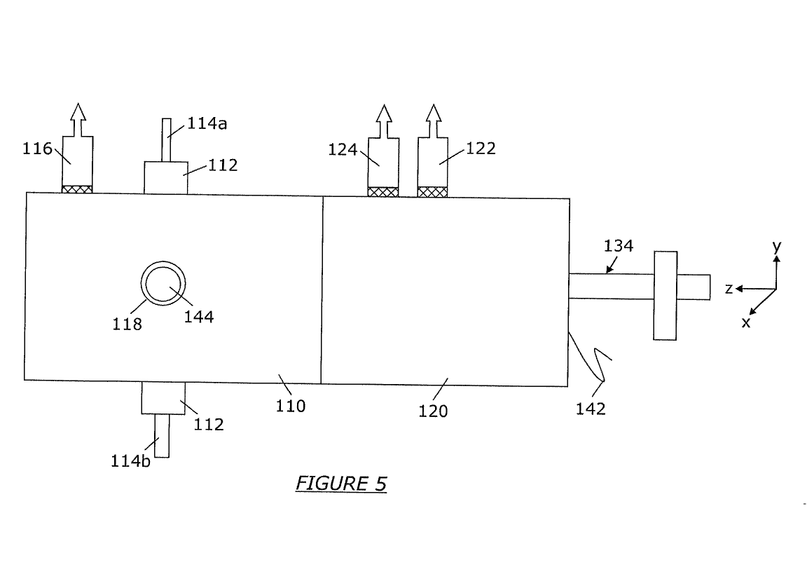

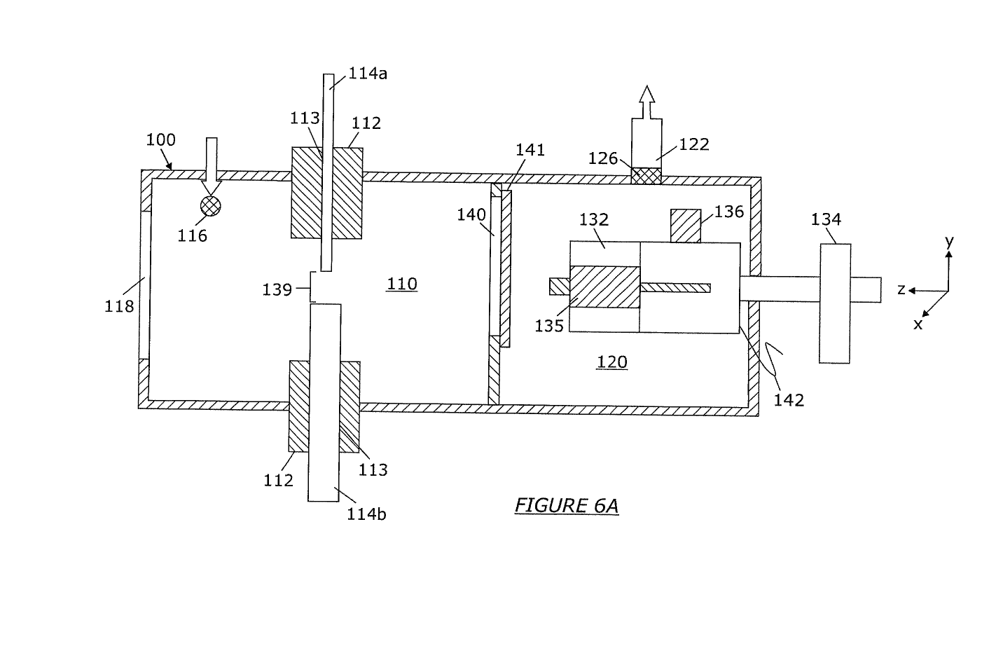

Various embodiments of the invention will now be described with reference to the accompanying drawings. FIG. 5 shows an apparatus 100 for fabricating a microlensed fiber in accordance with one embodiment of the invention. The apparatus 100 may also be used for fusion-splicing of fibers or for other processes involving use of a filament in general. The apparatus 100 comprises a first chamber 110 and a second chamber 120. The first chamber 110, hereafter referred to as the fiber chamber 110, is adapted to permit loading and aligning of fibers 114a, 114b for a fiber splicing or lens fabrication process. In the case of making microlensed fiber, either element 114a or 114b is a glass rod with no core. Preferably, element 114b is a glass rod. The second chamber 120, hereafter referred to as the filament chamber 120, is adapted to house a filament (not shown) in an inert atmosphere when the filament is not in active use, such as when fibers 114a, 144b are being loaded into or unloaded from the fiber chamber 110. The chambers 110, 112 may be made of a corrosion-resistant material such as stainless steel.

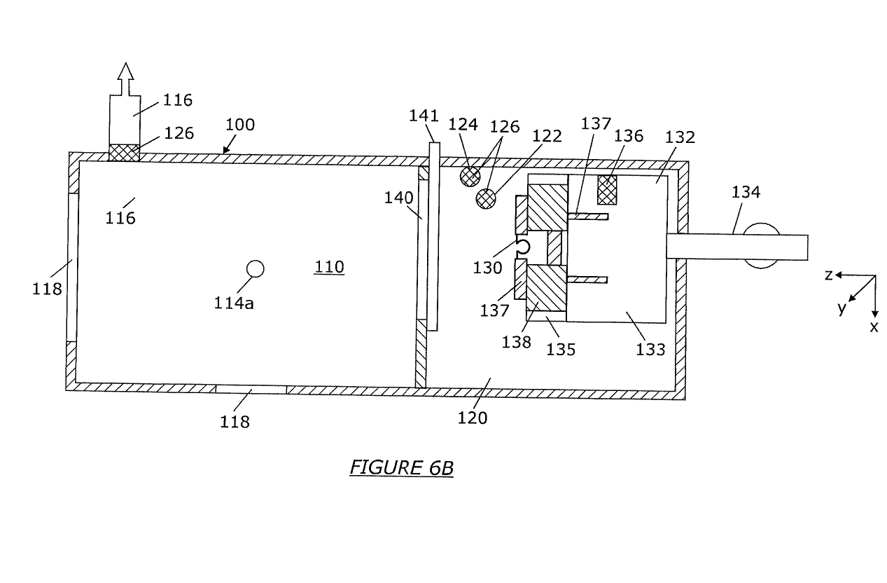

As shown in FIG. 6A, the fiber chamber 100 and the filament chamber 120 are connected by a closeable passage 140. The closeable passage 140 provides selective, substantial isolation of the filament chamber 120 from the fiber chamber 110. Preferably, the passage 140 is substantially airtight when closed to minimize airflow from the fiber chamber 110 into the filament chamber 120. In the illustrated embodiment, a door 141 is provided to block off or open the closeable passage 140. For convenience, the door 141 may be a sliding door that is slidable relative to the closeable passage 140. Alternatively, the door 141 may be a conventional hinged door, similar to those found in multiple-chamber glove boxes. In another embodiment, a gate valve (not shown) may be used in lieu of the door 141 to control access between the fiber chamber 110 and filament chamber 120. A gate valve is a seal when closed. Various types of gate valves suitable for this purpose are available from, for example, MDC Vacuum Products Corporation, Hayward, Calif.

When the apparatus 100 is used for fabricating a microlensed fiber, such as microlensed fiber 20 shown in FIG. 3, one of the fibers 114a, 114b is made of a lens material such as silica or borosilicate. In the following description, the fiber 114b is assumed to be the fiber that is made of a lens material. Hereafter, the fiber 114b may be referred to as lens material rod 114b. As can be seen in the drawing, the fiber 114b has a larger diameter than the fiber 114a. The fibers 114a, 114b are inserted into the fiber chamber 110 through fiber holders 112 coupled to opposite sides of the fiber chamber 110. The fiber holders 112 have grooves 113, such as V-grooves, for receiving the fibers 114a, 144b. In one embodiment, the apparatus 100 includes a conventional positioning device (not shown for clarity), such as an x-y-z stage or other actuator, coupled to each of the fiber holders 112 to enable controllable alignment of the fibers 114a, 114b within the fiber chamber 110. In one embodiment, the fiber chamber 110 includes one or more viewing ports 118, such as fused silica windows, which allow for the use of cameras (144 in FIG. 5) or other viewing devices to assist in alignment and prepositioning of the fibers 114a, 114b before the microlensed fiber is made.

A filament support structure 132 is disposed in the filament chamber 120. The filament support structure 132 comprises a head 133 which holds a filament cassette 135. As shown in FIG. 6B, the filament cassette 135 comprises an insulating plate 138 and electrodes 137 which extend through the insulating plate 138. One end of the electrodes 137 is coupled to a power supply (not shown) through, for example, leads 142. The other end of the electrodes 137 is coupled to a filament 130. The electrodes 137 support and provide power to the filament 130. In one embodiment, the filament 130 is made of tungsten. The filament support structure 132 is movable between the filament chamber 120 and the fiber chamber 110 through the closeable passage 140. In one embodiment, a positioning device 134, such as a y-z stage, is coupled to the filament support structure 132 to provide controllable alignment of the filament 130 with the fibers (114a, 114b in FIG. 6A) in the fiber chamber 110. An optical sensor 136 may also be coupled to the filament support structure 132 to detect a gap (139 in FIG. 6A) between the fibers (114a, 114b in FIG. 6A) to ensure, for example, that the filament 130 is centered at the gap (139 in FIG. 6A) prior to fusion splicing of the fibers (114a, 114b in FIG. 6A).

The filament chamber 120 maintains an inert atmosphere so that oxidation of the filament 130 is reduced. For example, a vacuum pump (not shown) may be coupled to a port 122 in the filament chamber 120 to evacuate the filament chamber 120. An inert gas source (not shown) may be coupled to a port 124 in the filament chamber 120 to supply the filament chamber 120 with an inert gas, such as argon or an argon-hydrogen mixture, so that a substantially air-free atmosphere can be maintained in the filament chamber 120. Baffles 126 may be provided at the ports 122, 124 to impede flow of gas into and out of the filament chamber 120. Mass flow controls (not shown) may be provided as necessary to control gas flow into and out of the filament chamber 120

Preferably, the fiber chamber 110 also maintains an inert atmosphere, at least around the filament 130, when the filament 130 is in use. For example, a port 116 in the fiber chamber 110 may be coupled to an inert gas source, such as argon. A vacuum pump (not shown) may be used to evacuate the fiber chamber 110 prior to pumping the inert gas into the fiber chamber 110. To minimize air leakage into the fiber chamber 110 during loading and unloading of fibers 114a, 114b, the inert gas is supplied into the fiber chamber 110 at a higher pressure than the ambient pressure. Mass flow controls (not shown) may be provided as necessary to control gas flow into and out of the fiber chamber 110.

Referring to FIG. 6A, to fabricate a microlensed fiber, the filament support structure 132, which holds the filament (130 in FIG. 6B), is first disposed in the filament chamber 120 in an inert atmosphere. At this time, the closeable passage 140 between the filament chamber 120 and the fiber chamber 110 is closed so that the fiber 114a and lens material rod 114b can be inserted into the fiber chamber 110 without exposing the filament (130 in FIG. 6B) to air. As the fiber 114a and lens material rod 114b are inserted into and aligned within the fiber chamber 110, the fiber chamber 110 is purged with the inert gas supplied through the port 116. The passage 140 is then opened to permit the filament support structure 132 to move into the fiber chamber 110.

When the filament (130 in FIG. 6B) is in the fiber chamber 110, power is supplied to the filament (130 in FIG. 6B) to form the microlensed fiber. To form the microlensed fiber, the fiber 114a and lens material rod 114b are spliced by pushing their opposing ends together while being heated by the filament (130 in FIG. 6B). After splicing, the filament (130 in FIG. 6B) is moved by a desired distance along the lens material rod 114b to taper (or cut) the lens material rod 114b to a desired length. After tapering the lens material rod 114b, the filament (130 in FIG. 6B) is moved towards the splice, i.e., the joint formed between the fiber 114a and the lens material rod 114b, by a distance that depends on the desired radius of curvature of the lens to be formed on the lens material rod 114b. In general, the closer the filament (130 in FIG. 6B) is to the splice, the larger the radius of curvature of the lens formed. After the microlensed fiber is formed, the filament support structure 132 is retracted back into the filament chamber 120, and the passage 140 is closed to preserve the inert atmosphere in the filament chamber 120. The microlensed fiber is then removed from the fiber chamber 110, and the process is repeated again for fabrication of other microlensed fibers.

Viewing devices, e.g., camera 144 in FIG. 5, may be used to capture the lens image and measure lens dimensions after the lens has been made. In general, it has been determined that the filament (130 in FIG. 6B) makes lenses with very reproducible radius of curvature when borosilicate glass is used. However, to make the correct length of lens, the position the filament (130 in FIG. 6B) should move to during the taper cut may need to be adjusted periodically using an algorithm that calculates the desired length of the lens. In one embodiment, the taper cut steps (or position the filament should move to) are adjusted based on measurement of thickness of the previous lens. In this embodiment, the adjustment is done so that the ratio of the thickness of the lens to the radius of curvature of the lens is substantially constant, as shown by the following equation:

$${T}_{new} = {T}_{old} + \frac{( \frac{{T}_{measured}}{{R}_{measured}} - \frac{{T}_{target}}{{R}_{target}} ) \cdot {R}_{measured}}{F} \qquad ( 1 )$$

where T_{new} is the adjusted number of taper cut steps for the next lens to be made, T_{old} is the number of taper cut steps used in making the previous lens, T_{measured} is the measured thickness of the lens, R_{measured} is the measured radius of curvature of the lens, T_{target} is the target thickness of the lens, R_{target} is the target radius of curvature of the lens, and F is the dampened step size of the splice head (133 in FIG. 6B) moving along the fiber-optic axis. Dampening is determined experimentally to achieve a stable process. Typically, the ratio T_{target}/R_{target} is about 3.5. Equation (1) above may be used to control the positioning device (134 in FIG. 6A) coupled to the filament support structure (132 in FIG. 6A).

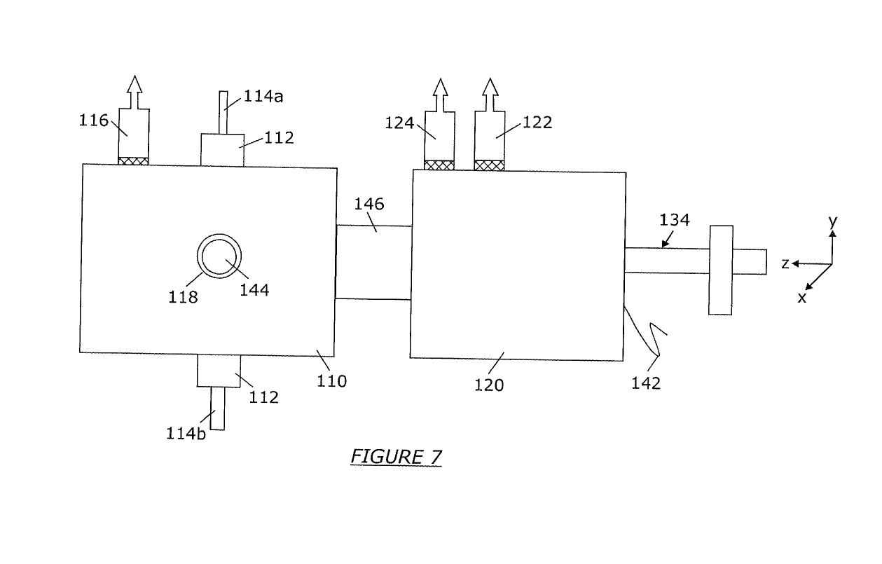

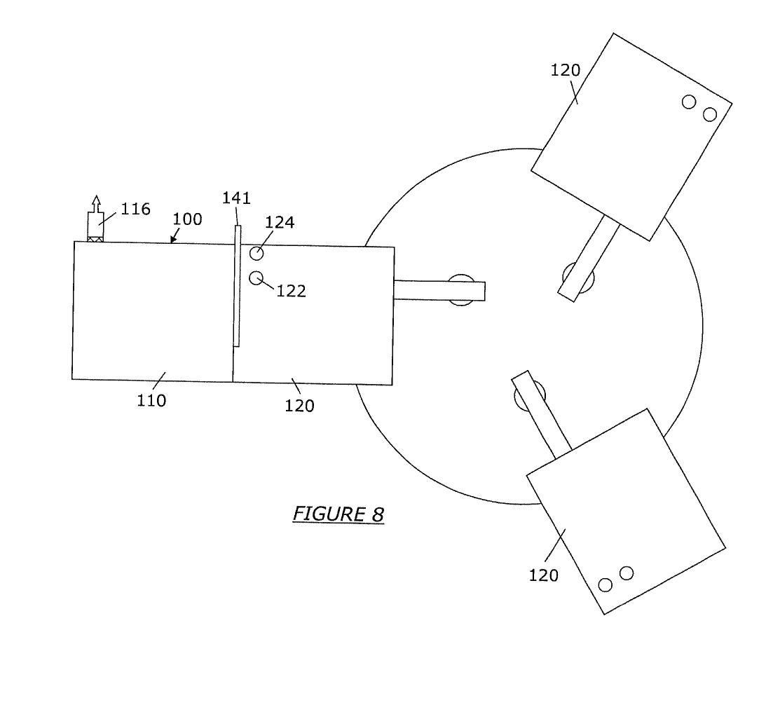

Those skilled in the art will appreciate that various modifications can be made to the apparatus 100 shown in FIGS. 5-6B which are within the scope of the invention. For example, as shown in FIG. 7, the fiber chamber 110 and filament chamber 120 may be structurally independent chambers, i e., not placed immediately adjacent to each other. The filament chamber 120 and fiber chamber 110 may be connected to a passage 146. One end of the passage 146 would communicate with the fiber chamber 110 through an aperture (not shown) in the fiber chamber 110, and the other end of the passage 146 would communicate with the filament chamber 112 through an aperture (not shown) in the filament chamber 112. The filament support structure (132 in FIG. 6B) could then pass through the passage 146 into the fiber chamber 110. One or both of the chambers 110, 120 may include a door (not shown) or gate valve adapted to selectively block the corresponding aperture (not shown) so that the filament chamber 120 can be selectively isolated from the fiber chamber 110, such as during loading and unloading of fibers 114a, 114b in the fiber chamber 110. Alternatively, a door, valve, or other closable device may be disposed in the passage 146.

In another embodiment, to facilitate removal of the filament (130 in FIG. 6B) when burnt out, the filament support structure (132 in FIG. 6B) and translation stage (134 in FIG. 6B) can be attached to a flange (not shown). The flange (not shown) may then be mounted on the filament chamber (120 in FIG. 6B). When it is desired to change the filament (130 in FIG. 6B), the flange can be quickly removed from the filament chamber (120 in FIG. 6B) and replaced with another flange that a filament support structure with a new filament and a translation stage attached to it. Alternatively, as shown in FIG. 8, multiple filament chambers 120 may be loaded on a turntable 148, or the like. Any one of the filament chambers 120 may be connected to the fiber chamber 110 at any given time while any burnt out filaments are replaced in the other filament chambers 120.

The invention may provide general advantages. By minimizing exposure of the filament to an oxidizing atmosphere during operation, the lifetime of the filament is increased. The configuration of the apparatus can be adjusted as necessary to allow for fabrication of larger lenses.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An apparatus for conducting a fusion process, comprising:
a first chamber;
a second chamber maintaining an atmosphere that is substantially free of oxygen;
a closeable passage connecting the first chamber and the second chamber, the closeable passage selectively providing substantial isolation of the second chamber from the first chamber; and
a filament normally disposed in the second chamber, the filament being movable between the second chamber and the first chamber when the closeable passage is in an open position.

2. The apparatus of claim 1, wherein the atmosphere in the second chamber comprises an inert gas.

3. The apparatus of claim 1, wherein the first chamber maintains an atmosphere that is substantially free of oxygen at least when the filament is in the first chamber.

4. The apparatus of claim 3, wherein the atmosphere in the first chamber comprises an inert gas.

5. The apparatus of claim 1, wherein a pressure inside the first chamber is greater than a pressure outside the first chamber.

6. The apparatus of claim 1, further comprising a pair of fiber holders coupled to the first chamber for inserting fibers into the first chamber.

7. The apparatus of claim 6, further comprising means for controllably aligning the fibers within the first chamber.

8. The apparatus of claim 6, wherein the first chamber comprises at least one viewing port.

9. The apparatus of claim 1, further comprising means for supplying power to the filament.

10. The apparatus of claim 1, wherein the filament is coupled to a support structure which is movable between the second chamber and first chamber through the closeable passage.

11. The apparatus of claim 10, further including means for moving the support structure such that the filament is aligned with the fibers.

12. The apparatus of claim 11, further comprising a detection means for detecting a gap between the fibers.

13. The apparatus of claim 1, wherein the closable passage comprises a gate valve.

14. The apparatus of claim 1, wherein the closeable passage comprises an aperture and a door member operable to selectively block off the aperture.

15. An apparatus for conducting a fusion process, comprising:
a first chamber;
a plurality of second chambers;
a closeable passage for connecting a selected one of the second chambers to the first chamber, the closeable passage selectively providing substantial isolation of the selected one of the second chambers from the first chamber;
a filament disposed in the selected one of the second chambers, wherein the selected one of the second chambers maintains an atmosphere that is substantially free of oxygen, the filament being movable between the selected one of the second chambers and the first chamber when the closeable passage is in an open position.

16. The apparatus of claim 15, wherein the second chambers are mounted on rotatable member.

17. An apparatus for fabricating a microlensed fiber, comprising:
a first chamber comprising a plurality of fiber holders through which fibers are inserted into the first chamber;
a second chamber maintaining a substantially inert atmosphere;
a closable passage disposed between the first chamber and the second chamber, the closable passage selectively providing substantial isolation of the second chamber from the first chamber; and
a filament normally disposed in the second chamber, the filament being movable between the second chamber and the first chamber when the closeable passage is in an open position.

18. The apparatus of claim 17, wherein the first chamber maintains an atmosphere that is substantially free of oxygen at least when the filament is in the first chamber.

19. A method for extending a lifetime of a filament used in a fusion process, comprising:
disposing the filament in a second chamber which maintains an atmosphere that is substantially free of oxygen;
extending the filament into a first chamber for the fusion process; and
retracting the filament back into the second chamber after the fusion process.

20. The method of claim 19, wherein the first chamber maintains an atmosphere that is substantially free of oxygen at least when the filament is extended into the first chamber.

21. The method of claim 19, further comprising maintaining the first chamber at a higher pressure than ambient pressure at least when the filament is extended into the first chamber.

22. A method for making microlensed fibers, comprising:
aligning a fiber and a rod made of lens material in a first chamber;
extending a filament from a second chamber which maintains an atmosphere that is substantially free of oxygen to the first chamber; and
fusion splicing the fiber to the rod and forming a lens from the rod using the filament.

23. The method of claim 22, further comprising retracting the filament back into the second chamber after forming the lens.

24. The method of claim 22, further comprising maintaining an atmosphere in the first chamber that is substantially free of oxygen at least when the filament is in extended into the first chamber.

25. The method of claim 22, further comprising maintaining the first chamber at a higher pressure than ambient pressure at least when the filament is extended into the first chamber.

26. The method of claim 22, wherein forming the lens from the rod comprises taper cutting the rod with the filament.

27. The method of claim 26, wherein taper cutting comprises adjusting a position of the filament relative to the rod based on a thickness of a previous lens formed with the filament.

28. The method of claim 27, wherein the position of the filament is adjusted such that a ratio of a thickness of the lens to a radius of curvature of the lens produced by the filament is substantially constant.
